(19) United States
(12) Patent Application Publication
(10) Pub. No.: US 2017/0335791 A1
(43) Pub. Date: Nov. 23, 2017

(54) Cylinder Head

(71) Applicant: Caterpillar Inc., Peoria, IL (US)

(72) Inventors: Andrew Schick, Edelstein, IL (US); Craig P. Hittle, Dunlap, IL (US); Odeta Andone, Dunlap, IL (US)

(73) Assignee: Caterpillar Inc., Peoria, IL (US)

(21) Appl. No.: 15/161,535

(22) Filed: May 23, 2016

(51) Int. Cl. F02F 1/24

(52) U.S. Cl. CPC F02F 1/242

(57) ABSTRACT

A cylinder head for an internal combustion engine includes a cylinder head body forming an injector bore, a fuel gallery having segments extending collinearly, two fuel supply passages in fluid communication with the fuel gallery, and two cross-drill passages terminating at a respective cross-drill opening. The two cross-drill passages extend generally parallel to the segments of the fuel gallery and are disposed at an offset distance therefrom such that the cross-drill openings are disposed closer to the right or left side of the cylinder head body.

### TECHNICAL FIELD

The present disclosure relates generally to reciprocating internal combustion engines and, more particularly, to a cylinder head for use with an internal combustion engine.

### BACKGROUND

Reciprocating internal combustion (IC) engines are known for converting chemical energy from a fuel supply into mechanical power. An air/fuel mixture is received in a variable volume of an engine cylinder, where it is compressed and burned. The burning mixture expands, thus providing mechanical work. The mechanical work produced by one or more engine cylinders is collected by various mechanisms and used to rotate a shaft, which provides useful engine work.

The variable volume is contained between a bore that includes a slidable piston therein. An open end of the bore is blocked by a cylinder head, which may also include passages for providing air and evacuating exhaust gases to and from the cylinder, and also passages for providing fuel to the cylinder. In direct injection engines, fuel is provided to the cylinder by a fuel injector, which is mounted into the cylinder head such that it injects fuel directly into the cylinder. Other arrangements include forming combustion pre-chambers, or indirect injection passages for providing fuel into the cylinder.

In typical engines, a fuel system provides filtered fuel at a desired pressure to the fuel injectors that are associated with the various cylinders of a multi-cylinder engine. The fuel system includes filters, pumps, fuel injectors, water scrubbers and other components that treat and pressurized the fuel that is provided to the cylinders for combustion. Fuel is transferred between these various components by use of tubes, hoses and other types of fluid conduits, which extend along the exterior of the engine between the various components. The exposure of the various fuel conduits to the environment, and also the relatively harsh operating environment in terms of contamination, vibration, heat and others, subject these conduits to wear such that, in a typical engine application, they are usually replaced or repaired at regular intervals.

In the past, it has been proposed to integrate at least some fuel passages into other engine components such as the cylinder head. One such example can be seen in U.S. Pat. No. 6,234,135 (the ′135 patent). The ′135 patent describes an engine having a cylinder head in which various fuel passages are integrated into the cylinder head to supply fuel to the various injectors. Return passages are also integrated into the cylinder head to collect unused fuel from the injectors for returning it to the fuel system. While the integrated fuel passages described in the ′135 patent may at least partially alleviate known fuel line issues for engines, these passages still rely on connections that are carried out at either or both longitudinal ends of the cylinder head, which are areas most prone to vibration and can thus lead to failure of the external lines connected to the fuel passages or of the connectors used to connect the passages to the external lines. Moreover, the integrated passages intersect bores in the cylinder head that accommodate therein the fuel injectors, thus creating segmented passages in the cylinder head, each of which includes seals on either end that are prone to wear and leakage.

### SUMMARY

In one aspect, the disclosure describes a cylinder head for an internal combustion engine. The cylinder head includes a cylinder head body having a flame deck surface, the flame deck surface being configured to engage a cylinder case of the internal combustion engine. The cylinder head body has a right side, a left side, a front side and a rear side with respect to an orientation of the cylinder head body when assembled onto the internal combustion engine. At least one injector bore is formed in the cylinder head body and is adapted to sealably accept therein a fuel injector. A fuel gallery is formed in the cylinder head body and includes at least two segments extending collinearly with respect to one another and disposed in fluid communication on either side of the at least one injector bore such that each of the at least two segments fluidly connects the injector bore with a respective end opening disposed at the front or the rear side of the cylinder head. Two fuel supply passages are formed in the cylinder head body and are in fluid communication with the fuel gallery. Each of the two fuel supply passages extends perpendicularly relative to the segments of the fuel gallery such that each of the two fuel supply passages fluidly connects the fuel gallery with a respective fuel supply opening. The two fuel supply openings are disposed on the right or left side of the cylinder head body. Two cross-drill passages are formed in the cylinder head body. Each of the two cross-drill passages terminates at a cross-drill opening. The two cross-drill passages extend generally parallel to the segments of the fuel gallery and are disposed at an offset distance therefrom such that the cross-drill openings are disposed closer to the right or left side of the cylinder head body. The two cross-drill passages are axially aligned with one another and each intersects a respective one of the two fuel supply passages at a right angle such that the cross-drill passages extend parallel to the collinear segments of the fuel gallery and perpendicular to the fuel supply passages. Each of the cross-drill openings is open to the front or rear sides of the cylinder head body.

In another aspect, the disclosure describes an internal combustion engine having a fuel system that includes a fuel pump and a fuel filter arranged and configured to provide a flow of fuel during engine operation to a fuel supply system that includes one or more fuel injectors. The internal combustion engine further includes a cylinder head forming a network of internal fuel passages that are fluidly part of the fuel supply system. A cylinder head body is defined as part of the cylinder head. The cylinder head body has a flame deck surface, which is configured to engage a cylinder case of the internal combustion engine. The cylinder head body has a right side, a left side, a front side and a rear side with respect to an orientation of the cylinder head body when assembled onto the internal combustion engine. At least one injector bore is formed in the cylinder head body and is adapted to sealably accept therein a fuel injector. A fuel gallery is formed in the cylinder head body and includes at least two segments extending collinearly with respect to one another and disposed in fluid communication on either side of the at least one injector bore such that each of the at least two segments fluidly connects the injector bore with a respective end opening disposed at the front or the rear side of the cylinder head. Two fuel supply passages are formed in the cylinder head body and are in fluid communication with the fuel gallery. Each of the two fuel supply passages extends perpendicularly relative to the segments of the fuel gallery such that each of the two fuel supply passages fluidly connects the fuel gallery with a respective fuel supply opening. The two fuel supply openings are disposed on the right or left side of the cylinder head body. Two cross-drill passages are formed in the cylinder head body. Each of the two cross-drill passages terminates at a cross-drill opening. The two cross-drill passages extend generally parallel to the segments of the fuel gallery and are disposed at an offset distance therefrom such that the cross-drill openings are disposed closer to the right or left side of the cylinder head body. The two cross-drill passages are axially aligned with one another and each intersects a respective one of the two fuel supply passages at a right angle such that the cross-drill passages extend parallel to the collinear segments of the fuel gallery and perpendicular to the fuel supply passages. Each of the cross-drill openings is open to the front or rear sides of the cylinder head body.

### BRIEF DESCRIPTION OF THE DRAWINGS

FIG. 1 is a schematic view of an engine fuel system in accordance with the disclosure.

FIG. 2 is a side detailed view of a fuel filter mounted onto an engine in accordance with the disclosure.

FIG. 3 is an outline view of a cylinder head in accordance with the disclosure.

FIG. 4 is a section view through the cylinder head of FIG. 3.

### DETAILED DESCRIPTION

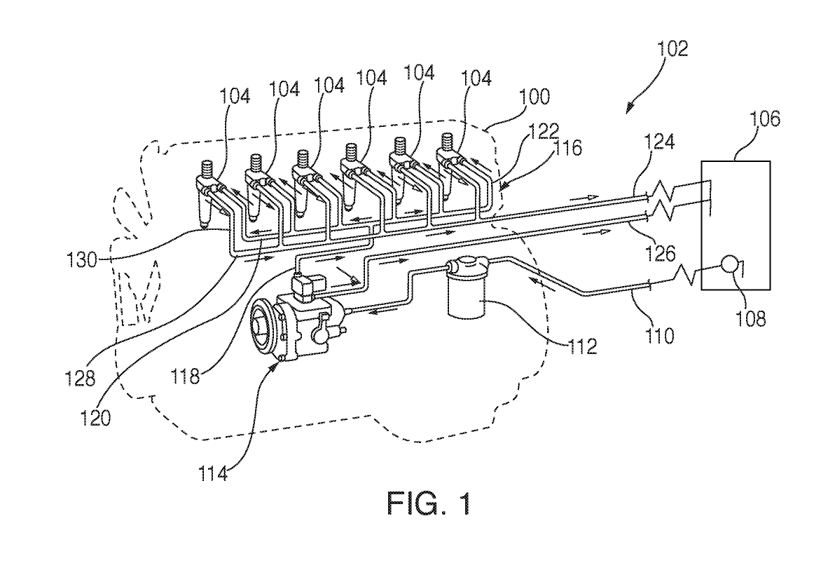

Aspects of the disclosure will now be described in detail with reference to the drawings, wherein like reference numbers refer to like elements throughout, unless specified otherwise. FIG. 1 shows a schematic view of an engine 100 having a fuel system 102 integrated therewith. The engine 100, which is shown as a phantom outline for illustration of internal components, includes the fuel system 102 for providing fuel to a plurality of fuel injectors 104. Each fuel injector 104 is associated with a respective cylinder of the engine 100 in the known fashion. A fuel tank 106 contains fuel, which is supplied to the fuel injectors 104. The fuel may be pushed from the fuel tank by a low pressure fuel pump 108, which provides fuel to a fuel supply conduit 110. A fuel filter module 112 is disposed along the fuel supply conduit to remove undesired substances from the fuel. The filter module 112 may include mechanical filters to remove debris, water scrubbers, de-aerators and other known devices used to treat fuel provided to internal combustion engines.

Treated fuel from the filter module 112 is provided to a fuel pump 114. The fuel pump 114 operates to increase the pressure of the fuel to a desired, injection pressure at which the fuel injectors 104 inject the fuel into the cylinders of the engine 100. Pressurized fuel from the fuel pump 114 is provided to a high pressure fuel line 116, which in the illustrated embodiment includes a pump segment 118, which is connected to an outlet of the pump 114, a fuel gallery segment 120, which provides pressure equalization across the various fuel injectors 104, and a plurality of fuel injector supply segments 122, each of which fluidly connects a respective fuel inlet port on each injector 104 with the fuel gallery segment 120.

Unused fuel at each injector 104 is returned to the tank 106 through a fuel return conduit 124, and unused fuel from the fuel pump 114 is likewise returned to the tank 106 via a pump return conduit 126. The fuel return conduit 124 includes a common segment 128, which is fluidly connected to the fuel return conduit 124 segment leading to the tank 106, and a plurality of injector fuel returns 130, each of which fluidly connects a respective fluid return port of a fuel injector 104 with the common segment 128.

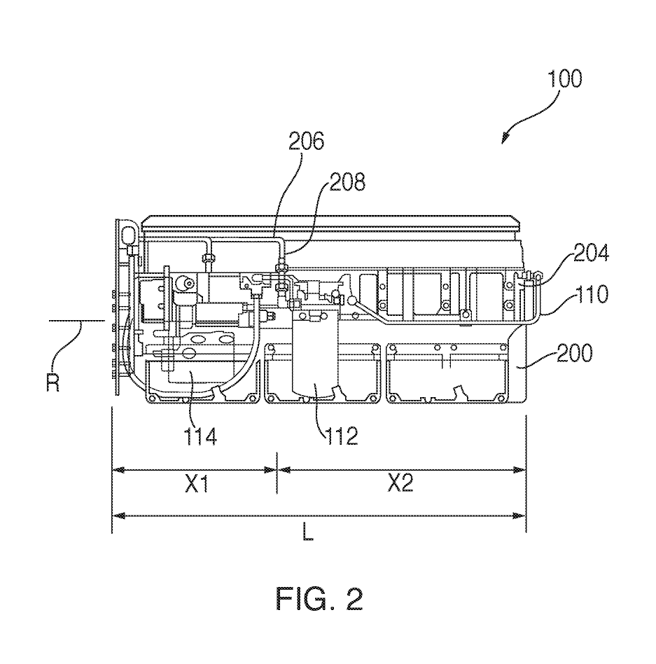

A side view of a portion of the engine 100 is shown in FIG. 2 to illustrate various engine components. In the view shown in FIG. 2, the engine 100 includes a cylinder case 202, which forms the various engine cylinders (not shown), and a cylinder head 204 connected to the cylinder case 202. The engine 100 has a “Vee” configuration and, accordingly, the view shown in FIG. 2 is a partially fragmented view to show the internal portion of the engine vee. Elements of the fuel system such as the fuel filter 112 and fuel pump 114 are denoted using the same reference numerals as used in FIG. 1 for simplicity. As can be seen, the fuel supply conduit 110 connects to the fuel filter 112. A high pressure fuel supply 206 from the fuel pump 114 is connected directly to a side of the cylinder head 204 at a fuel inlet location 208, which is located inside the engine vee.

In the prior art, fuel connections to the cylinder head were made either at the front or rear faces of the cylinder head, or on the outboard side of the cylinder heads. In the illustrated, exemplary embodiment, a location of the fuel inlet location 208 is close to the fuel filter 112 along an axis, R, which is parallel to a crankshaft axis of the engine 100 and is disposed closer to the center of the engine, within the vee. Specifically, the engine 100 as shown has an overall length, L, along the axis R, as shown. The fuel inlet location 208 is disposed a distance, X1, from the front of the engine 100, and a distance, X2, from the rear of the engine 100. In contrast to known engines, the fuel inlet location is closer to the middle of the engine than the ends, and also closer to the fuel filter, which generally shortens the external portions of the various fuel conduits. In the illustrated embodiment, the ratio of X1/X2 can be anywhere between 0 and 1, meaning, anywhere along the length of the engine, but in the internal vee region between the two engine cylinder banks.

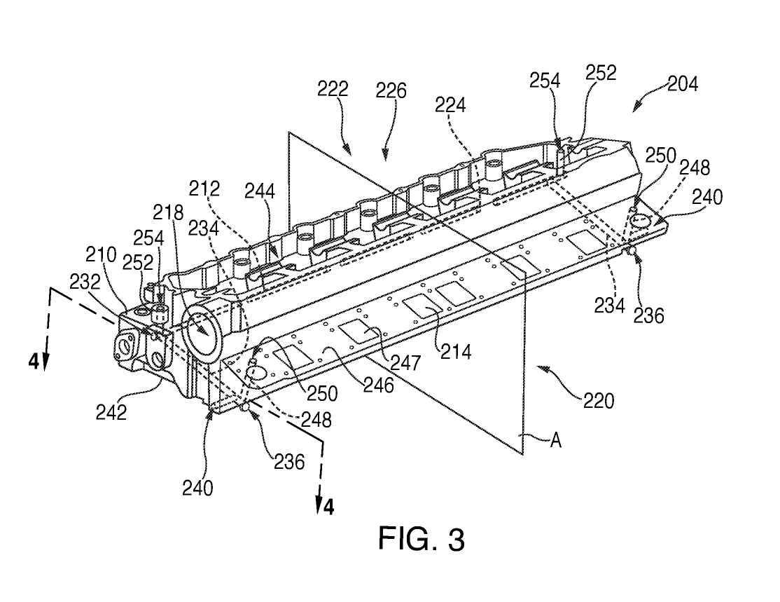

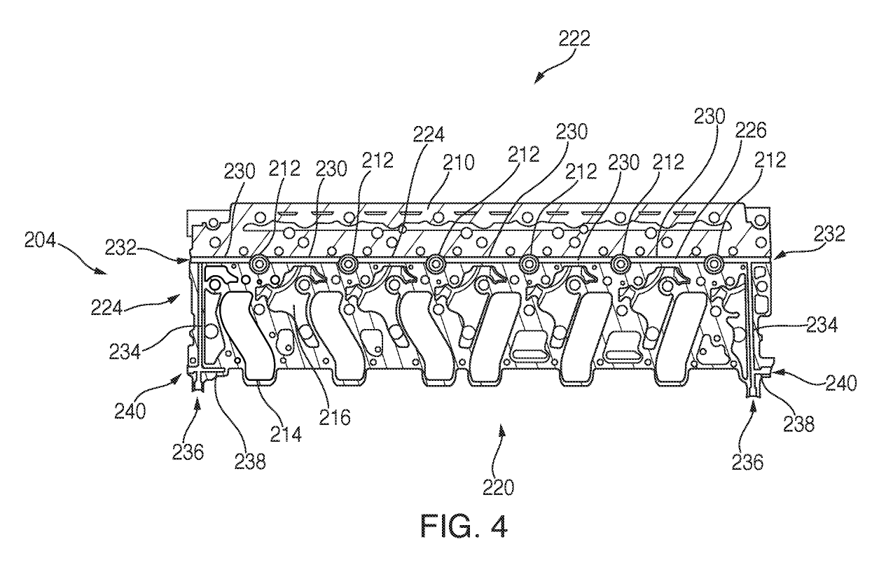

An outline view of a cylinder head 204 is shown in FIG. 3, and a section through the cylinder had 204 is shown in FIG. 4 to illustrate the internal structures thereof. In the illustration of FIG. 3, the outer geometry of the cylinder head is shown in phantom line and the internal fuel passages are shown in solid line for illustration. The particular cylinder head 204 is for a left engine bank, but it should be appreciated that a cylinder head for a right side engine bank of the engine might be the same as the cylinder head shown, or similar.

The cylinder head 204 includes a main body 210. The main body 210 forms a plurality of injector bores 212, each of which accommodates within a fuel injector 104 (FIG. 1). The main body has a right side, a left side, a front side and a rear side with respect to its orientation when assembled into the engine. It should be appreciated that the right, left, front and rear sides of the cylinder head are references to orientation for the sake of description and can assume and orientation depending on the orientation of the engine. When the cylinder head 204 is connected to the engine, the fuel injectors 104 are arranged to be associated with and protrude into the respective engine cylinders. The main body 210 further forms a plurality of passages 214, which may carry fresh air, a mixture of air and exhaust gas, or exhaust gas to or from the respective engine cylinders. In alternative embodiments, the passages 214 may further be used to carry a gaseous fuel into the cylinders. The cylinder head 204 further forms other openings to provide access for other engine components such as valve stems and the like, which are formed in the typical fashion and are not described further herein. The cylinder head 204 may further form internal coolant passages 216 that carry coolant during engine operation to cool the main body 210. In the embodiment shown, the main body 210 forms a camshaft bore 218 that rotatably accepts therein a camshaft to operate intake and exhaust valves that are mounted on the cylinder head to fluidly connect or isolate the engine cylinders, for example, to or from the passages 214.

The cylinder head 204 in accordance with disclosure has an inboard side 220 (in the cylinder head illustrated, the inboard side can also be referred to as the right side) and an outboard side 222 (left side) with respect to the orientation of its installation onto the engine. Accordingly, when the cylinder head is installed onto a cylinder case of a vee engine, the inboard side 220 is placed along a valley or internal region of the engine vee, while the outboard side 222 is placed along the exterior side portions of the engine. In accordance with the disclosure, the cylinder head 204 forms a plurality of internal passages for supplying fuel to and from the fuel injectors installed in the fuel injector bores 212.

More specifically, the cylinder head 204 forms an internal fuel gallery 224, which comprises a network of fuel passages 226 that can be formed in any appropriate fashion within the main body 210 of the cylinder head 204. In the illustrated embodiment, the fuel passages 226 are coplanar, but it should be appreciated that fuel passages can alternatively be formed at different angles relative to one another. Various passages are used by the engine and the fuel system during operation. In the illustrated embodiment, the internal fuel gallery 224, which is part of the fuel passages 226, includes collinearly extending segments 230 that extend along the cylinder head 204 and are segmented between the fuel injector bores 212. The segments 230, collectively, fluidly connect the fuel injector fuel inlets with the fuel gallery 224 to supply fuel to the fuel injectors during operation of the engine.

The fuel gallery 224 has two end openings 232 that provide fluid access to the fuel gallery 224 when the engine has been assembled. If not needed for fluid connections, the end openings can be plugged with plugs (not shown). The fuel gallery 224 is also in fluid communication with two fuel supply passages 234, which operate as fuel inlets or outlets to supply fuel to, or withdraw fuel from, the fuel gallery 224 during engine operation. In the illustrated embodiment, the fully supply passages 234 extend perpendicularly relative to the fuel gallery 224 and each terminates with a fuel supply opening 236. The fuel supply openings 236 are disposed on the inboard side 220 of the cylinder head 204. In this way, the fuel supply openings 236 on both banks on a vee engine face one another and flank the vee region of the engine to readily provide access thereto from the center or vee region of the engine. In the illustrated embodiment, various engine components such as the fuel filter, fuel pump and other fuel system components are mounted on the engine either within or in close proximity to the engine vee such that fuel lines and other fuel connection to or from the fuel supply passages 234 are shortened as compared to traditional or existing fuel connections of the type. Moreover, placement of the various fuel connections into the vee provides an additional advantage in protecting the various lines from damage as their majority is within the engine packaging envelope. Further, placement of the various fuel lines into the engine vee subjects the same to a reduced vibration during operation given the relatively shorter moment arm to the engine's crankshaft as compared to locations on the outboard side of the cylinder head 222 and the engine in general.

In the illustrated embodiment, the cylinder head 204 further includes two cross-drill passages 238, each terminating at a cross-drill opening 240. The cross-drill passages 238 extend generally parallel with the fuel gallery 224 but at an offset distance therefrom such that the cross-drill passages 238 are disposed closer to the inboard side 220 of the cylinder head 204. In the illustrated embodiment, two cross-drill passages 238 are shown. The two cross-drill passages 238 are axially aligned with one another and each intersects a respective one of the two fuel supply passages 234 at a right angle. In this way, the cross-drill passages 238 extend parallel to the collinearly extending segments 230 of the fuel gallery 224 and perpendicular to the fuel supply passages 234. Accordingly, each of the cross-drill openings 240 is open to the front or rear faces of the cylinder head 204 relative to the engine, to present additional fluid connection points to the fuel gallery 224 that are located on the engine in an area adjacent to the vee region on the inboard side 220 of the cylinder head 204 but outside of the vee region in either the front or the rear of the engine. When not needed for fluid connections to and from the fuel gallery 224, the cross-drill openings 240 can be plugged.

In reference now to FIG. 3, the cylinder head 204 includes a flame deck surface 242 that engages, sometimes via a gasket (not shown), the cylinder case (not shown) of the engine. The cylinder head further forms a gallery 244 that houses various engine components such as valve stems, springs and various valve activation components, which are generally known for engines and are thus not shown or described further herein. When the engine is assembled, the gallery 244 is enclosed by one or more valve covers (not shown), which are mounted on the cylinder head 204. The cylinder head 204 further forms a manifold interface 246, which includes openings 247 that are fluidly connected with the passages 214. When the engine is assembled, a manifold, in this case, one or more intake manifold components, are connected, via one or more gaskets, to the manifold interface 246 such that air can be provided to the engine cylinders, via the passages formed in the cylinder head 204, from the intake manifolds.

In the configuration shown, the manifold interface 246 is disposed on the inboard side 220 of the cylinder head 204. For facilitating the flow of fuel into and out from the fuel gallery 224, the cylinder head 204 further forms two risers 248, each terminating at a riser opening 250. Each of the two risers 248 extends perpendicularly with respect to a respective one of the two fuel supply passages 234, and also perpendicularly with respect to the cross-drill passages 238 and the fuel gallery 224 in an orthogonal, tri-axial configuration. Each riser 248 is also fluidly open to the respective fuel supply passage 234 disposed on either the front or the rear of the engine. The riser openings 250 are formed in the manifold interface 246 so that they are also located within or close to the engine vee region, which is disposed adjacent the inboard side 220 of the cylinder head 204. When the engine is assembled, each of the riser openings 250 can be used instead of, or in addition to, the fuel supply openings 236 and/or the cross-drill openings 240 to supply fuel to, or to remove fuel from, the fuel gallery 224.

The cylinder head 204 further forms two gallery risers 252 close to the front and rear of the cylinder head 204 as it is installed on the engine. Each gallery riser 252 forms a gallery riser opening 254, which can be used to provide fluid connections to the fuel gallery 224, for example, for fuel pressure sensors and the like, or may be plugged if not in use. The gallery risers 252 extend perpendicular to the fuel gallery 224 and are fluidly open therewith. In an axial direction relative to the cylinder head 204, the gallery risers 252 in the illustrated embodiment are placed closer to the center of the cylinder head 204 than the risers 248, but other axial locations can be used. It is noted that, in the illustrated embodiment, the location and paths of the various internal passages and their respective openings that are formed in the cylinder head 204 are placed in a symmetrical fashion with respect to a plane, A, extending through the center of the cylinder head 204 along the axial direction from front to rear of the cylinder head 204 such that the same pierce points or interface points are presented towards the front and the rear of the engine when two cylinder heads are installed on the engine, where one cylinder head is rotated by 180 degrees relative to the other when installed on the right and left engine banks such that the inboard sides 220 of the two cylinder heads 204 face one another.

### INDUSTRIAL APPLICABILITY

The present disclosure is applicable to internal combustion engines and, in particular, to engines that include a cylinder case having a cylinder head connected thereto. The cylinder head in accordance with the disclosure includes integrated fuel passages that provide fuel to fuel injectors mounted into the cylinder heads and positioned to directly inject fuel into the cylinders of the engine. The integrated passages have fluid access openings positioned close to or adjacent the sides, front and back of the cylinder head to provide ready access for supplying and removing fuel therefrom from using shorter and more protected fuel lines. In a vee engine, for example, as shown in the exemplary embodiment described herein, the fuel inlets and outlets are disposed close to or into the vee or central portion of the engine to reduce exposure of fuel lines connected to the internal passages of the cylinder head to damage and vibration. In a computational study, the internal passages are further advantageous in that as much as a 10% reduction in pressure drop of fuel passing through the passages was estimated. The reduction can be attributed, in part, to the multiple access points that can be used to fluidly connect to a fuel gallery formed in the cylinder head for supplying fuel to the fuel injectors attached to the cylinder head. It should further be appreciated that, although a cylinder head for a vee engine is shown, the passages can advantageously also be formed in a cylinder head for an inline engine, and even a cylinder head for a single-cylinder.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. A cylinder head for an internal combustion engine, comprising:
a cylinder head body having a flame deck surface, the flame deck surface configured to engage a cylinder case of the internal combustion engine, the cylinder head body having a right side, a left side, a front side and a rear side with respect to an orientation of the cylinder head body when assembled onto the internal combustion engine;
at least one injector bore formed in the cylinder head body, the at least one injector bore being adapted to sealably accept therein a fuel injector;
a fuel gallery formed in the cylinder head body, the fuel gallery including at least two segments extending collinearly with respect to one another and disposed in fluid communication on either side of the at least one injector bore such that each of the at least two segments fluidly connects the injector bore with a respective end opening disposed at the front or the rear side of the cylinder head;
two fuel supply passages formed in the cylinder head body and being in fluid communication with the fuel gallery, each of the two fuel supply passages extending perpendicularly relative to the segments of the fuel gallery such that each of the two fuel supply passages fluidly connects the fuel gallery with a respective fuel supply opening, wherein the two fuel supply openings are disposed on the right or left side of the cylinder head body; and
two cross-drill passages formed in the cylinder head body, each of the two cross-drill passages terminating at a cross-drill opening, the two cross-drill passages extending generally parallel to the segments of the fuel gallery and disposed at an offset distance therefrom such that the cross-drill openings are disposed closer to the right or left side of the cylinder head body;
wherein the two cross-drill passages are axially aligned with one another and each intersects a respective one of the two fuel supply passages at a right angle such that the cross-drill passages extend parallel to the collinear segments of the fuel gallery and perpendicular to the fuel supply passages; and
wherein each of the cross-drill openings is open to the front or rear sides of the cylinder head body.

2. The cylinder head of claim 1, wherein the cylinder head body further forms a manifold interface, the manifold interface including openings that are fluidly connected with passages extending through the cylinder head body for providing air to engine cylinders when the cylinder head is assembled and operates with the internal combustion engine.

3. The cylinder head of claim 2, wherein the manifold interface is disposed on the right or left side of the cylinder head body.

4. The cylinder head of claim 2, wherein the cylinder head body further forms two risers, each of the two risers terminating at a riser opening, wherein each of the two risers extends perpendicularly with respect to a respective one of the two fuel supply passages, and also extends perpendicularly with respect to each of the two cross-drill passages and also the collinear segments of the fuel gallery in an orthogonal, tri-axial configuration.

5. The cylinder head of claim 4, wherein each riser is fluidly open to a respective fuel supply passage such that the riser openings are formed in the manifold interface.

6. The cylinder head of claim 1, wherein the cylinder head body further forms two gallery risers close to the front and rear sides of the cylinder head body, wherein each gallery riser forms a gallery riser opening, which gallery riser opening provides fluid connection access to the fuel gallery.

7. The cylinder head of claim 6, wherein each of the two gallery risers extends perpendicular to the segments of the fuel gallery and is fluidly open therewith.

8. The cylinder head of claim 7, wherein, in an axial direction relative to the cylinder head, the gallery risers are placed closer to a center of the cylinder head than the risers.

9. The cylinder head of claim 8, wherein the fuel gallery, the supply passages, the cross-drill passages, the risers and the gallery risers together define a network of internal passages formed in the cylinder head, and wherein the network of internal passages and respective openings are placed in a symmetrical fashion with respect to a plane extending through the center of the cylinder head along an axial direction from the front side to the rear side of the cylinder head.

10. The cylinder head of claim 1, wherein the cylinder head body is asymmetrical and arranged to be placed on a vee engine, the cylinder head body having an inboard side and an outboard side with respect to an engine placement orientation, and wherein the fuel supply openings and the cross-drill openings are disposed closer to the inboard side than the outboard side.

11. An internal combustion engine having a fuel system that includes a fuel pump and a fuel filter arranged and configured to provide a flow of fuel during engine operation to a fuel supply system that includes one or more fuel injectors, the internal combustion engine further comprising:
a cylinder head forming a network of internal fuel passages that are fluidly part of the fuel supply system;
a cylinder head body defined as part of the cylinder head, the cylinder head body having a flame deck surface, the flame deck surface configured to engage a cylinder case of the internal combustion engine, the cylinder head body having a right side, a left side, a front side and a rear side with respect to an orientation of the cylinder head body when assembled onto the internal combustion engine;
at least one injector bore formed in the cylinder head body, the at least one injector bore being adapted to sealably accept therein at least one of the one or more fuel injectors;
a fuel gallery formed in the cylinder head body, the fuel gallery including at least two segments extending collinearly with respect to one another and disposed in fluid communication on either side of the at least one injector bore such that each of the at least two segments fluidly connects the injector bore with a respective end opening disposed at the front or the rear side of the cylinder head;
two fuel supply passages formed in the cylinder head body and being in fluid communication with the fuel gallery, each of the two fuel supply passages extending perpendicularly relative to the segments of the fuel gallery such that each of the two fuel supply passages fluidly connects the fuel gallery with a respective fuel supply opening, wherein the two fuel supply openings are disposed on the right or left side of the cylinder head body; and
two cross-drill passages formed in the cylinder head body, each of the two cross-drill passages terminating at a cross-drill opening, the two cross-drill passages extending generally parallel to the segments of the fuel gallery and disposed at an offset distance therefrom such that the cross-drill openings are disposed closer to the right or left side of the cylinder head body;
wherein the two cross-drill passages are axially aligned with one another and each intersects a respective one of the two fuel supply passages at a right angle such that the cross-drill passages extend parallel to the collinear segments of the fuel gallery and perpendicular to the fuel supply passages; and
wherein each of the cross-drill openings is open to the front or rear sides of the cylinder head body.

12. The internal combustion engine of claim 11, wherein the cylinder head body further forms a manifold interface, the manifold interface including openings that are fluidly connected with passages extending through the cylinder head body for providing air to engine cylinders when the cylinder head is assembled and operates with the internal combustion engine.

13. The internal combustion engine of claim 12, wherein the internal combustion engine further includes a cylinder case having two cylinder banks arranged in a vee configuration, wherein the cylinder head is disposed on a left bank of the cylinder case, and wherein the manifold interface is disposed on the right side of the cylinder head body, which is also an inboard side of the cylinder head body.

14. The internal combustion engine of claim 12, wherein the cylinder head body further forms two risers, each of the two risers terminating at a riser opening, wherein each of the two risers extends perpendicularly with respect to a respective one of the two fuel supply passages, and also extends perpendicularly with respect to each of the two cross-drill passages and also the collinear segments of the fuel gallery in an orthogonal, tri-axial configuration.

15. The internal combustion engine of claim 14, wherein each riser is fluidly open to a respective fuel supply passage such that the riser openings are formed in the manifold interface.

16. The internal combustion engine of claim 11, wherein the cylinder head body further forms two gallery risers close to the front and rear sides of the cylinder head body, wherein each gallery riser forms a gallery riser opening, which gallery riser opening provides fluid connection access to the fuel gallery.

17. The internal combustion engine of claim 16, wherein each of the two gallery risers extends perpendicular to the segments of the fuel gallery and is fluidly open therewith.

18. The internal combustion engine of claim 17, wherein, in an axial direction relative to the cylinder head, the gallery risers are placed closer to a center of the cylinder head than the risers.

19. The internal combustion engine of claim 18, wherein the fuel gallery, the supply passages, the cross-drill passages, the risers and the gallery risers together define a network of internal passages formed in the cylinder head, and wherein the network of internal passages and respective openings are placed in a symmetrical fashion with respect to a plane extending through the center of the cylinder head along an axial direction from the front side to the rear side of the cylinder head.

20. The internal combustion engine of claim 11, wherein the fuel supply openings and the cross-drill openings are disposed closer to the inboard side than the outboard side.
